(19) United States
(12) Patent Application Publication
(10) Pub. No.: US 2006/0254041 A1
(43) Pub. Date: Nov. 16, 2006

(54) Flared liner method of securing thermoplastically lined metal pipe

(76) Inventor: Alfredo G. Levario, Odessa, TX (US)

Correspondence Address: GENE W. ARANT, P.O. BOX 269, LINCOLN CITY, OR, 97367-0269, US

(21) Appl. No.: 11/388,029

(22) Filed: Mar. 24, 2006

Related U.S. Application Data
(63) Continuation-in-part of application No. 10/027,308, filed on Dec. 21, 2001, now Pat. No. 7,107,662.

(51) Int. Cl. B23P 11/00

(52) U.S. Cl. 29/505; 29/451

(57) ABSTRACT

The method of securing the end of an internal thermoplastic liner for a steel pipe, in which a protruding end portion of the liner is heated and expanded and then secured in a manner to minimize interference with the conduction of liquid flowing inside the thermoplastic liner.

### CROSS-REFERENCE TO RELATED APPLICATION

This application is a continuation-in-part of my copending application Ser. No. 10/027,308 filed 12/21/2001, and incorporates herein by reference the drawings and description of that application, the same as if fully set forth herein. The issue fee for that prior application has been paid so it will become U.S. Pat. No. ______.

### FIELD OF THE INVENTION

The field of this invention is metal pipes used in transmitting liquid and/or gases, and particularly such pipes which are equipped with an internal thermoplastic liner for protecting the metal from excessive corrosion and other problems.

### BACKGROUND OF THE INVENTION

It is a common practice to employ metal pipes, typically steel, equipped with an internal thermoplastic liner for transmitting water, raw petroleum, petroleum products, many other types of corrosive liquids, and/or chemically active gases. The principal purpose of the thermoplastic liner is to prevent or restrict corrosion of the metal and thus extend the useful life of the pipe. The thermoplastic liner may also have other purposes, such as monitoring the integrity of the metal pipeline itself.

When any gas component is being transmitted the transmission pressures can be very high, such as 2000 pounds per square inch. Any material used for the thermoplastic liner is then easily permeated by the gas. It is necessary to reliably control any leakage or escape of gas from the liner material, and it is also desirable to control or avoid any build-up of excess gas pressure in the liner that might result in an explosion.

Although steel pipe is commonly manufactured which contains a thermoplastic liner co-extensive with each pipe section, thermoplastic liners are sometimes installed separately from the installation of the pipes themselves. Thermoplastic liners can shrink or stretch. There are various known techniques for handling the thermoplastic liners to ensure their mechanical support and effective sealing.

When metal pipe sections are coupled together it is necessary to pay particular attention to the manner of coupling and/or otherwise securing the associated permeable liners. Many different types of pipe joint structures involving thermoplastic liners have been known and used. The pipe joint structure needs to meet any special requirements that may exist for the liner, in addition to meeting all requirements for the metal pipe itself.

### SUMMARY OF THE INVENTION

According to the present invention I have discovered that the optimum method of securing a thermoplastic liner in a pipe joint is to form an end portion of the liner into a slightly flared or conical surface configuration, and then clamp the flared liner portion in place. For best mechanical results the angle of the flare should be between five degrees and fifteen degrees, and preferably about eight degrees.

According to the invention the preferred method of forming the slightly flared or conical configuration of the end portion of the liner is to use a heated mold that is inserted inside the end portion of the liner, while at the same time bathing the exterior surface of the liner end in hot air.

In a typical pipe joint, according to the present invention the liner ends of both associated pipe sections are formed into a flared conical surface configuration. I prefer to use a rigid inner support ring or coupler to provide rigid support for the flared end portions of both thermoplastic liners, and a circumferential collar placed around the flared end portions of the liners. The coupler has longitudinally sloped outer surfaces on both of its ends, to align with the inner surfaces of the flared liner ends, and the collar has a matingly shaped inner surface. I also provide mechanical means for securing both the support ring and the collar in their proper positions, radially and longitudinally, relative to the associated metal pipe section or sections.

A special application of the invention is in conjunction with thermoplastic liners that have longitudinally extending grooves formed in their exterior surfaces to facilitate the flow of gas that has permeated through the liner into its external grooves. According to my invention the adjacent pipe sections are then coupled in such a way as to accommodate the flow of gas from the grooves in the thermoplastic liner of one pipe section into the grooves of the thermoplastic liner of the adjoining pipe section, all as disclosed in more detail in my copending application.

### SUMMARY OF SEPARATE INVENTION

. As a separate and distinct invention, I have discovered that the flared end portion of a thermoplastic liner may be clamped in place without obstructing the flow of liquid inside an associated pipe section. I accomplish this by using an inner clamp member having an inner surface which is essentially a continuation of the main flow path for the liquid. Thus, the liner is securely anchored but without detracting from the functionality of the pipeline.

### DRAWING SUMMARY

FIG. 1 is an artistic illustration, partly in elevation, partly in cross-section, and partly in schematic form, showing near-final steps when the method of the present invention is used in joining two pipe sections and securing their respective liners;

FIG. 2(a) is a line drawing which shows the cross-section of a flared liner in accordance with the invention, indicating the preferred angle of flare;

FIG. 2(b) schematically illustrates clamping of the flared end of a liner in such a way as not to obstruct the liquid flow channel within the liner; and

FIG. 3 is a cross-sectional view of a metal pipe with a thermoplastic liner that has longitudinal grooves in its exterior surface.

### DESCRIPTION OF THE METHOD

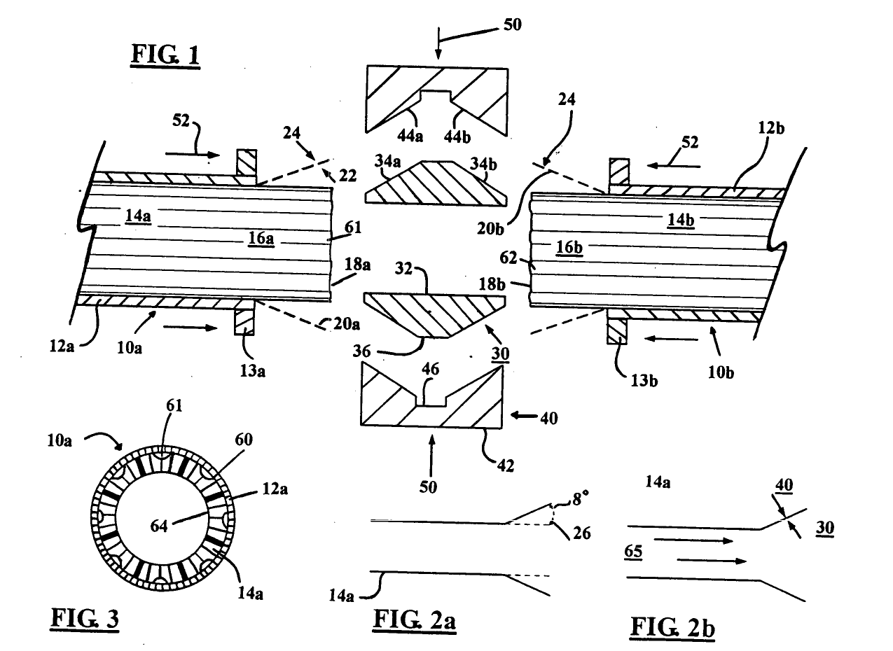

### FIGS. 1-4

As shown in FIG. 1, a pair of internally lined metal pipe sections 10a, 10b are to be coupled together. Each has had an end portion cut or trimmed off, leaving a metal body 12a, 12b upon which a metal flange 13a, 13b has been welded. An internal thermoplastic liner 14a, 14b contained within each respective pipe section has a protruding end portion 16a, 16b the extremity of which is designated 18a, 18b.

According to my invention the preferred method of forming the slightly flared or conical configuration of the end portion of the liner is to use a heated mold that is inserted inside the end portion of the liner, while at the same time bathing the exterior surface of the liner end in hot air. Arrows 22 indicate the application of heat inside the liner while arrows 24 indicate the application of heat that concurrently bathes the outside surface of the liner.

Dotted lines 20a, 20b show the intended positions of the liner end portions after the flaring operation has been accomplished. There is an angle 26 between each flare location 20a, 20b, and the original outer surface location of the protruding liner portion 16a, 16b. According to my method the angle 26 should preferably be between a minimum of five degrees and a maximum of 15 degrees. The optimum flare angle is about eight degrees. The flared end portion of the liner provides a basis for mechanical securement of the liner end not only in a radial direction, but also longitudinally with respect to the associated pipe section, because both the support ring 30 and the collar 40 will be firmly secured in fixed longitudinal relation to the associated pipe sections 10a and 10b.

As also shown in FIG. 1, the rigid support ring or coupler 30 is available to be placed inside the liner end portions 16 when they are flared out to positions indicated by the dotted lines 20a, 20b. On its outer surface the ring 30 has sloped end edge surfaces 34a, 34b which will mate with the inner surfaces of the flared liner end portions, when the liner end portions are moved into the positions shown by dotted lines 20a, 20b. In FIG. 2(b) the support ring 30 is schematically shown as the inner clamp member.

It is important that in accordance with my invention the flared end portion of a thermoplastic liner may be clamped in place without obstructing a liquid flow channel inside it. Thus coupler or inner clamp member 30 has an inner surface 32 which is of cylindrical configuration and whose diameter is generally identical to the inner diameter of the main liner portions 14a, 14b. This provides an unobstructed continuation of the main flow channel for a liquid that may be carried in the pipeline, as indicated by arrows 65 in FIG. 2(b). The end portion of each liner is therefore securely anchored but without detracting from the functionality of an associated pipeline.

Collar 40 is shown in FIG. 1 in a schematic form only. There is a central outer surface portion 42 of collar 40 which is of cylindrical configuration. The function of collar 40 is to radially compress the flared end portions 16a, 16b of the liners after they have become internally supported by the rigid coupler or inner support ring 30. Thus, on its interior circumferential surface the collar 40 has sloping edge surfaces 44a, 44b which will fit snugly against the outer surfaces of flared liner portions 16a, 16b, after they assume positions 20a, 20b, and matingly compress the liners against the coupler 30.

In one preferred embodiment as shown in my copending application, a particular joint mechanism is employed to radially clamp the flared conical end portions of the two thermoplastic liners while at the same time providing a fixed support for their positions relative to the associated pipe sections. In that preferred embodiment a mechanism for securely holding two adjacent pipe sections together is combined with a mechanism for anchoring the positions of the liner ends. In that particular embodiment the pipe sections are provided with flanges having conical inner surfaces to match the flared liner ends.

Inner surface 32 of support ring 30 is not sloped, but is parallel to the recessed central interior surface 46 of the collar 40. Because of the recessed nature of surface 46, the inner surface 32 of ring 30 together with the recess 46 of collar 40 forms an annular space, which has a very important function.

FIG. 3 is a cross-sectional view of a typical metal pipe section with thermoplastic liner having longitudinally extending grooves formed in its exterior surface. The outer circumferential surface of liner 14a is designated as 60. It has longitudinally extending grooves 61 the purpose of which is to facilitate the flow of gas that has permeated through the liner into those external grooves. Adjacent pipe sections may then be coupled in such a way as to accommodate and greatly facilitate the flow of gas from the grooves in the liner of one pipe section into the grooves of the liner of the adjoining pipe section, all as disclosed in more detail in my copending application.

FIG. 1 illustrates the pipe sections 10a, 10b as having longitudinally extending grooves liners 61, 62 formed on the exterior surfaces of the associated liners 14a, 14b. Since the grooves 61 of pipe section 10a may not be aligned with grooves 62 of pipe section 10b, it is important that a longitudinal space be provided which separates the extremity 18a of liner 14a from the extremity 18b of liner 14b. Longitudinal separation is provided by the annular space located between the central outer surface 36 of support ring or coupler 30 and the central inner surface 46 of collar 40. As a result, gas flowing longitudinally within one of the grooves 62 in pipe section 12b may flow circumferentially for a short distance until it enters one of the grooves 61 in pipe section 12a to continue flowing in a longitudinal direction.

According to my invention, the flared end portion of a thermoplastic liner may be clamped in place without obstructing the flow of liquid inside an associated pipe section. See FIG. 2(b). I accomplish this by using an inner clamp member 30 having an inner surface 32 which is essentially a continuation of the main flow path 65 for the liquid. Thus, the liner is securely anchored but without detracting from the functionality of the pipeline. In FIG. 2(b) the numeral 40 schematically illustrates the collar 40.

Although FIG. 1 illustrates the collar 50 in a schematic form only, it should be understood that various types of mechanical arrangements may be made which will not only suffice to hold the ends of the thermoplastic liners securely in place but will also serve as mechanically strong joints for the ends of adjacent pipe sections.

While the present drawings and description have outlined the significant theory of the present invention, and in compliance with statutory requirements of the patent laws have described in detail how the invention may be carried out, persons skilled in the art will nevertheless understood that the scope of the invention is to be adjudged only in accordance with the appended claims.

### PARTS LIST

10a, 10b metal pipe section with liner
12a, 12b metal after trimming pipe length
13a, 13b pipe flange
14a, 14b liner main portion
16a, 16b protruding end portion of liner
18a, 18b outer end extremity of liner
20a, dotted lines showing flared position that liner portion 16a will assume
20bdotted lines showing flared position that liner portion 16b will assume
22 (arrow) application of heat inside liner
24 heat applied outside (arrow showing)
26 angle of flare (indicated in FIG. 2(a))
30 rigid inner support ring (shown only in cross-section in FIG. 1)
32 inner circumferential wall of ring
34a, 34b sloping outer side edges of ring
36 central outer surface of ring
40 collar
42 outer circumferential surface of collar
44a, 44b sloped inner edge surfaces of collar
46 recessed central inner surface of collar
(Annular space between 36 and 46 has no No.)
50 arrows indicating collar compression inward
52 arrows indicating longitudinal securement of pipe sections towards each other
60 outer circumferential surface of liner 14a in FIG. 3
61 grooves in surface 60
62 grooves in surface of the other liner 14b, only in FIG. 1
64 inside circumferential surface of the liner 14a (forms the liquid channel)
65 arrows showing liquid flow in channel 64
Note : In FIG. 2(a) we show the liner only in an outline form (no cross-section)
FIG. 2(b) inner clamp member arrow represents support ring 30 outer clamp member arrow represents collar 40.
In FIG. 2(b) the inner clamp 30 does not obstruct liquid 65.

What I claim is:

1. A method of coupling together two sections of metal pipe, each having a thermoplastic internal liner, comprising the steps of:
(a) heating an outer end portion of each liner while also flaring it outward into a conical surface configuration;
(b) placing a rigid inner support ring between the two pipe sections for supporting the flared portions of the liners in their flared configuration;
(c) placing the pipe sections that are to be joined in longitudinally aligned relation and with the flared liners extending over the outer surface of the rigid support ring; and
(d) placing a circumferential collar around the flared portions of the liners to provide radial compressive force on them to hold them securely in place on the inner support ring.

2. The method of claim 1 wherein the protruding portions of the liners are heated both internally and externally while they are being formed into the flared configuration.

3. A method as in claim 1 wherein the angle of flare is about eight degrees.

4. A method as in claim 1 wherein the thermoplastic liner associated with each pipe section has longitudinally extending grooves formed in its exterior surface to facilitate the flow of gas, and adjacent pipe sections are then coupled in such a way as to accommodate the flow of gas from the liner of one pipe section into the liner of the adjoining pipe section.

5. The method of claim 4 in which the extremities of the liners are placed in close proximity to each other but not in face-to-face engagement.

6. The method of claim 1 wherein the thermoplastic liner associated with each pipe section has longitudinally extending grooves formed in its exterior surface to facilitate the flow of gas, and the collar provides an annular space within which gas may more circumferentially while flowing from the longitudinal grooves in the liner of one pipe section into the longitudinal groove of the other pipe section.

7. In a pipeline having an internal thermoplastic liner of generally cylindrical configuration, the method of fastening the end of the liner in its place, comprising the steps of:
(a) while applying heat to an elongated end portion of the liner, expanding that end portion outward into a slightly flared or conical configuration wherein the angle of flare is more than five but less than fifteen degrees;
(b) selecting a pair of rigid members with mating conical surfaces to fit the inside and outside surfaces of the flared liner;
(c) placing the rigid members about the flared end portion of the liner in engagement therewith; and
(d) then clamping the rigid members together to securely hold the end portion of the liner in place.

8. The method of claim 7 which includes the further step of securing both of the rigid members in fixed positions both radially and longitudinally relative to an associated section of the metal pipe.

9. The method of claim 7 wherein the angle of flare is about eight degrees.

10. A method of securing the end of a thermoplastic liner in a pipe joint assembly, comprising the steps of:
(a) forming an end portion of the liner into a slightly flared or conical surface configuration with an angle of the flare between five degrees and fifteen degrees;
(b) providing rigid mechanical support for the end portion of the liner in its flared configuration by placing a rigid inner support ring inside the flared end portion of the liner and a circumferential collar around the flared end portion of the liner and clamping them together; and
(c) securing both the inner support ring and the circumferential collar in fixed positions both radially and longitudinally relative to an associated metal pipe section.

11. A method as in claim 10 wherein the slightly flared or conical configuration of the end portion of the liner is formed by inserting a heated mold inside the liner end while also bathing the exterior surface of the liner end in hot air.

12. A method as in claim 10 wherein two pipe sections are joined together, the adjacent ends of the associated pipe sections are formed into with a conical inner surface configuration, and the inner support ring has an essentially cylindrical interior surface which allows uninterrupted flow of liquid inside the pipe.
